(19) United States
(12) Patent Application Publication
(10) Pub. No.: US 2026/0267921 A1
(43) Pub. Date: Sep. 10, 2026

(54) AUTOMATED PROBLEM DECOMPOSITION FOR ANALYTIC ORCHESTRATION

(71) Applicants: RTX BBN Technologies, Inc., Cambridge, MA (US); Raytheon Company, Arlington, VA (US)

(72) Inventors: Brian Edward Ulicny, Winchester, MA (US); Joshua Swenson Fasching, Watertown, MA (US); Frederick E. Bernardin, Somerville, MA (US); Plamen Vaskov Petrov, Springfield, VA (US); Christine Rachael Nezda, Richardson, TX (US); Joshua A. Binkley, Plano, TX (US)

(21) Appl. No.: 19/558,023

(22) Filed: Mar. 5, 2026

Related U.S. Application Data
(60) Provisional application No. 63/767,767, filed on Mar. 6, 2025.

(51) Int. Cl. G06F 16/9032

(52) U.S. Cl. CPC G06F 16/9032

(57) ABSTRACT

A method includes processing, by one or more computing devices: a request for information; a system prompt associated with answering the request for information; and background tradecraft data associated with the request for information. The method includes generating, by the one or more computing devices, an answer associated with the request for information, based on processing the request for information, the system prompt, and the background tradecraft data.

### CROSS-REFERENCE TO RELATED APPLICATIONS

This application claims the benefit of priority to U.S. Provisional Application No. 63/767,767 filed Mar. 6, 2025, the disclosure of which is incorporated herein by reference in its entirety.

### BACKGROUND

The present disclosure relates to problem analysis, in particular, to automated problem decomposition for analytic orchestration.

Some analysts are tasked with answering overarching intelligence questions from a superior, a manager, or the like. For example, in the intelligence field, an analyst may be tasked with answering overarching intelligence questions from a commander. In another example, in the financial sector, an analyst may be tasked with answering overarching financial questions from a manager. Efficient techniques for effectively generating answers to such overarching questions are desired.

### SUMMARY

Example embodiments of the present disclosure are directed to a method including: processing, by one or more computing devices: a request for information; a system prompt associated with answering the request for information; and background tradecraft data associated with the request for information; and generating, by the one or more computing devices, an answer associated with the request for information, based on processing the request for information, the system prompt, and the background tradecraft data.

In any one or combination of the embodiments disclosed herein, generating the answer associated with the request for information is further based on processing, by the one or more computing devices, ontology data associated with the request for information.

In any one or combination of the embodiments disclosed herein, generating the answer associated with the request for information is further based on processing, by the one or more computing devices, a catalogue of data associated with the request for information.

In any one or combination of the embodiments disclosed herein, the method may further include: generating one or more sub-questions associated with the request for information, based on processing the request for information, the system prompt, and the background tradecraft data, wherein generating the answer associated with the request for information is based on the one or more sub-questions.

In any one or combination of the embodiments disclosed herein, the method may further include: applying respective weighting factors to each of the one or more sub-questions associated with the request for information, wherein generating the answer associated with the request for information is based on applying the respective weighting factors.

In any one or combination of the embodiments disclosed herein, the method may further include: generating one or more sub-answers corresponding to the one or more sub-questions, wherein generating the answer associated with the request for information is based on at least a portion of each of the one or more sub-answers.

In any one or combination of the embodiments disclosed herein: the one or more sub-questions are generated by a model included in the one or more computing devices; and the answer is generated by one or more agents included in the one or more computing devices.

In any one or combination of the embodiments disclosed herein, the request for information and the answer are associated with providing military intelligence.

Example embodiments of the present disclosure are directed to a system configured to: process a request for information, a system prompt associated with answering the request for information, and background tradecraft data associated with the request for information; and generate an answer associated with the request for information, based on processing the request for information, the system prompt, and the background tradecraft data.

In any one or combination of the embodiments disclosed herein, the system is configured to generate the answer based on processing ontology data associated with the request for information.

In any one or combination of the embodiments disclosed herein, the system is configured to generate the answer based on processing a catalogue of data associated with the request for information.

In any one or combination of the embodiments disclosed herein, the system is further configured to: generate one or more sub-questions associated with the request for information, based on processing the request for information, the system prompt, and the background tradecraft data, wherein generating the answer associated with the request for information is based on the one or more sub-questions.

In any one or combination of the embodiments disclosed herein, the system is further configured to: apply respective weighting factors to each of the one or more sub-questions associated with the request for information, wherein generating the answer associated with the request for information is based on applying the respective weighting factors.

In any one or combination of the embodiments disclosed herein, the system is further configured to: generate one or more sub-answers corresponding to the one or more sub-questions, wherein generating the answer associated with the request for information is based on at least a portion of each of the one or more sub-answers.

In any one or combination of the embodiments disclosed herein, the system may further include one or more computing devices including: a model; and one or more agents, wherein: the model is configured to generate the one or more sub-questions; and the one or more agents are configured to generate the answer based on the one or more sub-questions.

Example embodiments of the present disclosure relate to an apparatus including: a memory having computer readable instructions and one or more processors for executing the computer readable instructions, wherein the computer readable instructions, when executed by the one or more processors, cause the apparatus to: process a request for information, a system prompt associated with answering the request for information, and background tradecraft data associated with the request for information; and generate an answer associated with the request for information, based on processing the request for information, the system prompt, and the background tradecraft data.

In any one or combination of the embodiments disclosed herein, generating the answer associated with the request for information is further based on processing, by the one or more processors, ontology data associated with the request for information.

In any one or combination of the embodiments disclosed herein, generating the answer associated with the request for information is further based on processing, by the one or more processors, a catalogue of data associated with the request for information.

In any one or combination of the embodiments disclosed herein, the computer readable instructions, when executed by the one or more processors, further cause the apparatus to: generate one or more sub-questions associated with the request for information, based on processing the request for information, the system prompt, and the background tradecraft data, wherein generating the answer associated with the request for information is based on the one or more sub-questions.

In any one or combination of the embodiments disclosed herein, the computer readable instructions, when executed by the one or more processors, further cause the apparatus to: apply respective weighting factors to each of the one or more sub-questions associated with the request for information, wherein generating the answer associated with the request for information is based on applying the respective weighting factors.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE SEVERAL VIEWS OF THE DRAWINGS

For a more complete understanding of this disclosure, reference is now made to the following brief description, taken in connection with the accompanying drawings and detailed description, wherein like reference numerals represent like parts.

FIG. 1 illustrates an example of a system that supports automated problem decomposition for analytic orchestration in accordance with one or more embodiments of the present disclosure.

FIG. 2 illustrates an example flowchart of a method in accordance with one or more embodiments of the present disclosure.

FIG. 3 illustrates an example hierarchical modeling of complex intelligence problems which may be determined by a workflow using an LLM and LLM agents in accordance with one or more embodiments of the present disclosure.

FIG. 4 is a block diagram of a distributed computer system, in which various aspects and functions discussed herein may be practiced.

FIG. 5 illustrates an example flowchart of a method in accordance with one or more embodiments of the present disclosure.

### DETAILED DESCRIPTION

A detailed description of one or more embodiments of the disclosed apparatus and method are presented herein by way of exemplification and not limitation with reference to the Figures.

Analysts may be tasked with answering overarching intelligence questions from a superior, a manager, or the like. For example, in the intelligence field, an analyst may be tasked with answering overarching intelligence questions (e.g., regarding adversary intents, entities, events, strategies, or the like) from a commander. In another example, in the financial sector, an analyst may be tasked with answering overarching financial questions from a manager (e.g., stocks to invest in, portfolio management, or the like).

Systems and techniques are described herein which support effective problem decomposition in various areas such as, for example, the intelligence field (e.g., military intelligence), the financial sector, the legal field, a clinical setting, forensic analysis, and corporate markets. Embodiments of the present disclosure include applying generative model technologies to break down a top level question into sub-questions, applying agents to answer the sub-questions, and providing a complete answer based on respective answers to the sub-questions. In some non-limiting examples, the generative model technologies may include large language model (LLM)-based technologies, and the agents may be LLM agents. The systems and techniques described herein provide effective problem decomposition having increased accuracy and reduced turnaround time compared to manual approaches. For example, in the intelligence field (and similarly, the financial sector, the legal field, a clinical setting, forensic analysis, and corporate markets), manual processing of large volumes of data has historically been a highly resource-intensive, time-consuming, and error prone process.

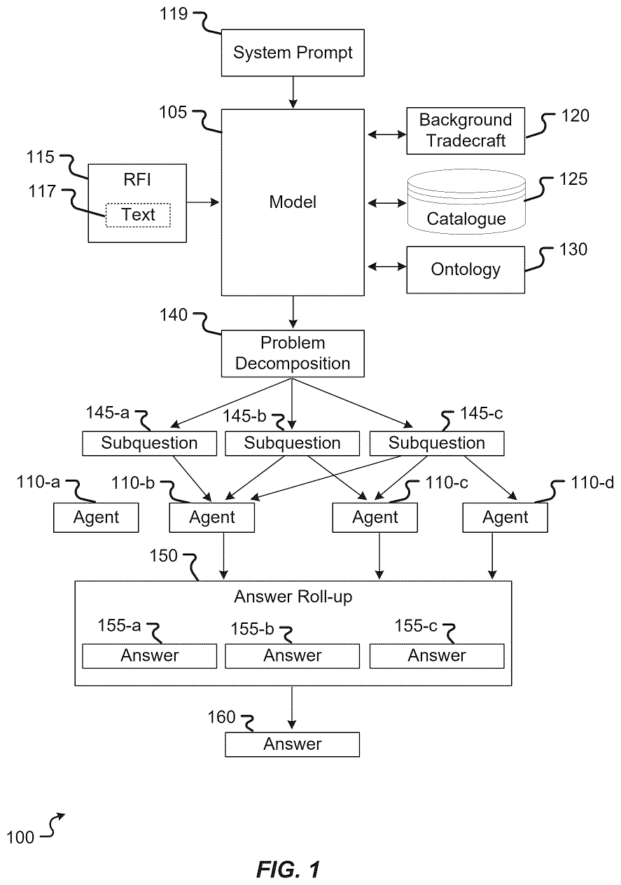

FIG. 1 illustrates an example of a system 100 that supports automated problem decomposition for analytic orchestration in accordance with one or more embodiments of the present disclosure. The system 100 may include a model 105 and agents 110. The system 100 may implement a workflow for automated problem decomposition for analytic orchestration in accordance with one or more embodiments of the present disclosure.

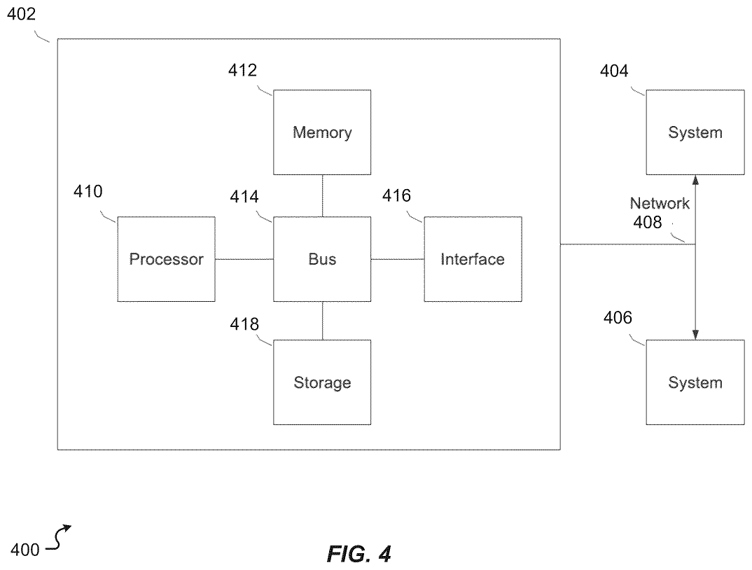

In some embodiments, the model 105 and the agents 110 may be implemented in a computing system, example aspects of which are later described with reference to FIG. 4. In some other embodiments, the model 105 and/or the agents 110 may be separate from and coupled to the computing system.

The model 105 may be an artificial intelligence (AI) model trained on various data (e.g., text data, image data, video data, and other modalities and combinations thereof). The model 105 may be trained based on relatively large datasets and be capable of understanding and processing natural language. The model 105 may be referred to as a pretrained generative model.

The agents 110 are AI systems that use models (in some cases, LLMs, but are not limited thereto) to understand, generate, and imitate human language. In some aspects, the agents 110 may be built on algorithms that are trained on large amounts of text data. The agents 110 may be designed for context-awareness, multi-step task execution, and decision-making, specialized with respect to a target field (e.g., the intelligence field, the financial sector, the legal field, a clinical setting, forensic analysis, corporate markets, or the like). The agents 110 may be registered with the system 100 and be triggerable by natural language sub-questions (e.g., sub-questions 145 later described herein) generated by the model 105. The agents 110 are configured to respond in natural language in the LLM context.

An example of an automated problem decomposition workflow implemented by the model 105 and the agents 110 is described herein. The workflow may include providing guidance to the model 105 on how to decompose a request for information (RFI) 115 (i.e., an overarching question) into sub-questions 145 addressable on the basis of background tradecraft 120 (also referred to herein as background tradecraft), a catalogue 125 of available information, an ontology 130 of relevant entities and events, and text 117 of the RFI 115. In an example, the systems and techniques described herein may include initiating the workflow based on a system prompt 119 associated with answering the RFI 115.

The background tradecraft 120 (also referred to herein as background tradecraft data) may include the techniques, methods, and technologies used as part of providing assessments (e.g., intelligence assessments, financial assessments, legal assessments, clinical assessments, forensic analysis, corporate market assessments, or the like).

The catalogue 125 may be a catalogue of available data sources, already collected. Non-limiting examples of the data sources may include public or private sources. For example, the data sources may include websites, online books, research papers, code repositories, or the like, but are not limited thereto.

The ontology 130 (also referred to herein as ontology data) may include a representation of the categories, properties, and relations between concepts, data, or entities. The ontology 130 may include formal naming and definitions of the concepts. The ontology 130 may be a formal representation of a domain of knowledge, including a taxonomy as an integral part, with an underlying vocabulary including definitions of terms representing universals, defined classes, and axioms from which rational arguments can be made.

Any of the data received, processed, and generated as described herein (e.g., system prompt 119, RFI 115, background tradecraft 120, catalogue 125, ontology 130, Answer 160) may be stored at a data source (e.g., a database, a server, a computing device, a storage device, or the like) accessible by the system 100 and/or input via a computing device associated with the system 100.

The model 105 may perform problem decomposition 140 based on the text 117 of the RFI 115, the system prompt 119, the background tradecraft 120, the catalogue 125, and the ontology 130. Through performing problem decomposition 140, the model 105 may generate the sub-questions 145. The sub-questions 145 may be essential elements of information (EEIs) which are answerable on the basis of the collected data (e.g., data provided via the catalogue 125).

In some aspects, the model 105 may generate suggestions regarding additional data to collect. In an example, based on processing the additional data, the model 105 may modify the sub-questions 145 (previously generated by the model 105) and/or generate additional sub-questions 145.

The workflow may include generating answers to the sub-questions 145. For example, one or more of the agents 110 may generate the answers. In some embodiments, the workflow may include applying weights to each of the sub-questions 145. The weights may be user-provided. Additionally, or alternatively, the weights may include derived weights. Based on use case, the workflow may apply equal weights to the sub-questions 145 or different respective weights to the sub-questions 145.

The workflow may include performing answer roll-up 150, which may include rolling up an overall answer to an answer 160 corresponding to the RFI 115. For example, one or more of the agents 110 may roll-up (i.e., aggregate or combine, partially or in full) the answers into the answer 160, by default weighing all the evidence (e.g., sub-questions 145) equally. Additionally, or alternatively, one or more of the agents 110 may roll-up the answers into the answer 160, by weighing some evidence sources (e.g., one or more sub-questions 145) more highly than others.

As illustrated at FIG. 1, the system 100 may include multiple agents 110. The techniques described herein may include performing answer roll-up using any combination of the agents 110. In the non-limiting example of FIG. 1, agent 110-a is not involved in answering any of the sub-questions 145, agent 110-b provides an answer 155 based on sub-question 145-a through sub-question 145-c, agent 110-c provides an answer 155 based on sub-question 145-b and sub-question 145-c, and agent 110-d provides an answer 155 based on sub-question 145-c.

Accordingly, for example, a single agent 110 may be involved in answering a single or multiple sub-questions 145, a subset of agents 110 may be involved in answering a single or multiple sub-questions 145, and/or an agent 110 may not be involved in answering any sub-questions 145.

As has been described herein, the workflow provides an automated LLM-directed approach to providing an answer 160 to an RFI 115, with increased accuracy and reduced turnaround time compared to other approaches (e.g., manual approaches). For example, the model 105 may be configured such that the model 105 contains a relatively great deal of information about what would constitute evidence for empirical questions. The agents 110 are capable of generating answers (e.g., answers 155, answer 160) relatively quickly compared to other approaches.

Accordingly, for example, the answers provided by the agents 110 may enable analysts to quickly evaluate results and modify collections or assessment (e.g., evidence weights) on the basis of the answers. In contrast, manual approaches for answering a RFI 115 may typically be a relatively very long process. Accordingly, for example, the system 100 provides an assistive tool for analysis, and in some cases, may be implemented to provide a full answer 160 autonomously.

As has been described herein, the system 100 is based on providing tradecraft (e.g., background tradecraft 120) and personal background information to a model 105 to mimic an intelligence analyst, as well as an ontology 130 of relevant action and event types and a catalogue 125 of available information. The system 100 may use agents 110 to answer sub-questions 145 generated by the model 105 and roll the answers 155 (also referred to herein as sub-answers) up to an answer 160 to the RFI 115.

Aspects of the system 100 described herein illustrate an example architecture of an agent based decision support environment supported by the present disclosure. In some embodiments, the system 100 may be applied to the domain of (Airborne Warning and Control System (AWACS) Command and Control, in which human controllers are to make critical decisions under strict timing constraints in a dynamically changing environment. The decision support training environment is based on distributed simulation, tightly coupled with an intelligent agent infrastructure including the agents 110 described herein. The agents 110 may apply heuristics based algorithms to provide decision support to the human controllers.

An example implementation of applying the workflow described with reference to FIG. 1 to the intelligence field is described herein.

The RFI 115 may be a priority intelligence request, and the text 117 of the RFI 115 may include the following question: “Will adversary vessels use aggressive maneuvers to disrupt friendly forces in the vicinity of ‘Geographical Region A’?”

The system prompt 119 may include the following text: “You are a US Naval Intelligence analyst working in the ‘Geographical Region A’ in July 2023. For this Request For Information (RFI), break down the request by means of a hierarchy of entity, entity states, indicators and observations that entail the entity state, and how the indicators and how the observations could be collected. For each indicator, please provide specific questions to address for each of the adversaries provided by the publicly available information (PAI) context.”

The background tradecraft 120 may include techniques, methods, and technologies used as part of providing intelligence assessments (e.g., military assessments, espionage assessments, or the like).

The catalogue 125 may include, for example, automatic identification system (AIS) tracking data associated with monitoring and tracking ships, news reports (e.g., printed articles, online-based articles, text transcriptions of video or audio news reports, or the like), cable vessel locations, and munitions capabilities (e.g., missile capabilities), but is not limited thereto.

The ontology 130 may include, for example, aggressive maneuvers, hostile activities, and maritime infrastructure, but is not limited thereto.

As a result of the problem decomposition 140, the model 105 outputs the following example sub-questions 145: Aggressive maneuvers observed or reported? Encounters with friendly forces? Public statements, propaganda, or media activity by the adversary? Increased naval vessel presence?

As a result of the agents 110 answering the sub-questions 145, applying different respective weights to the sub-questions 145 (i.e., generating unequally weighted answers 155), and performing answer roll-up 150, the agents 110 provide the following in an answer 160.

### 1. Presence of Adversary Vessels

Indicator: Significant increase in adversary vessels near ‘Geographical Region A’. Assessment: Presence is above normal levels, suggesting heightened activity. Status: (Red)—High concern.

### 2. Aggressive Maneuvers

Indicator: Some reported incidents of close approaches or posturing by adversary vessels. Assessment: Maneuvers are more frequent but remain below critical levels. Status: (Yellow)—Medium concern.

### 3. Communication and Coordination

Indicator: Significant spike in communication activity among adversary vessels. Assessment: Communications suggest coordinated action or preparations, with clear signs of organization. Status: (Red)—High concern.

### 4. Proximity to Friendly Forces

Indicator: Adversary vessels are maintaining expected distances from friendly forces. Assessment: Proximity is being maintained within expected norms, no immediate threat of collision. Status: (Green)—Low concern.

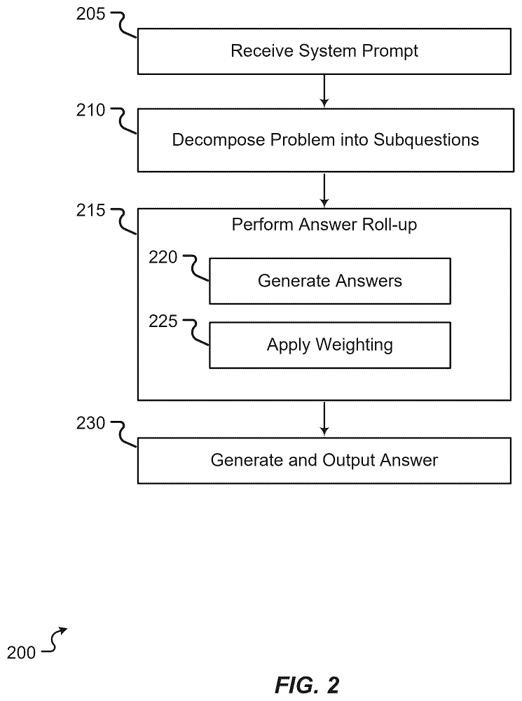

FIG. 2 illustrates an example flowchart of a method 200 in accordance with one or more embodiments of the present disclosure. The method 200 may be implemented by a model 105 and agents 110 described herein. Aspects of the method 200 are described with reference to FIG. 1.

At 205 of the method 200, the model 105 may receive a system prompt 119.

At 210 of the method 200, the model 105 may decompose a problem corresponding to the RFI 115 into sub-questions 145 (i.e., generating sub-questions 145) based on background tradecraft 120, a catalogue 125 of available information, an ontology 130 of relevant actions and events, and text 117 of the RFI 115. Decomposing the problem corresponding to the RFI 115 into sub-questions 145 may also be referred to as decomposing the RFI 115 into sub-questions 145.

At 215 of the method 200, the agents 110 may perform answer roll-up. In an example, at 220 of the method 200, the agents 110 may generate answers 155 corresponding to the sub-questions 145. In some cases, at 225, the method 200 may include applying different respective weights (also referred to herein as weighting factors) to the answers 155. In some other cases, the method 200 may apply equal weights to the answers 155. It is to be understood that applying equal weights to the answers 155 may include refraining from applying any weights to the answers 155. In some aspects, the agents 110 may generate an answer 155 to a sub-question 145 based on querying an underlying datastore and performing calculations on the basis of the sub-question 145.

At 230 of the method 200, the agents 110 may generate and output the answer 160 based on the answers 155. In some examples, the agents 110 may generate the answer 160 based on the answers 155 and weights applied to the answers 155. In some aspects, the agents 110 may generate the answer 160 based on querying the underlying datastore and performing calculations on the basis of the sub-questions 145.

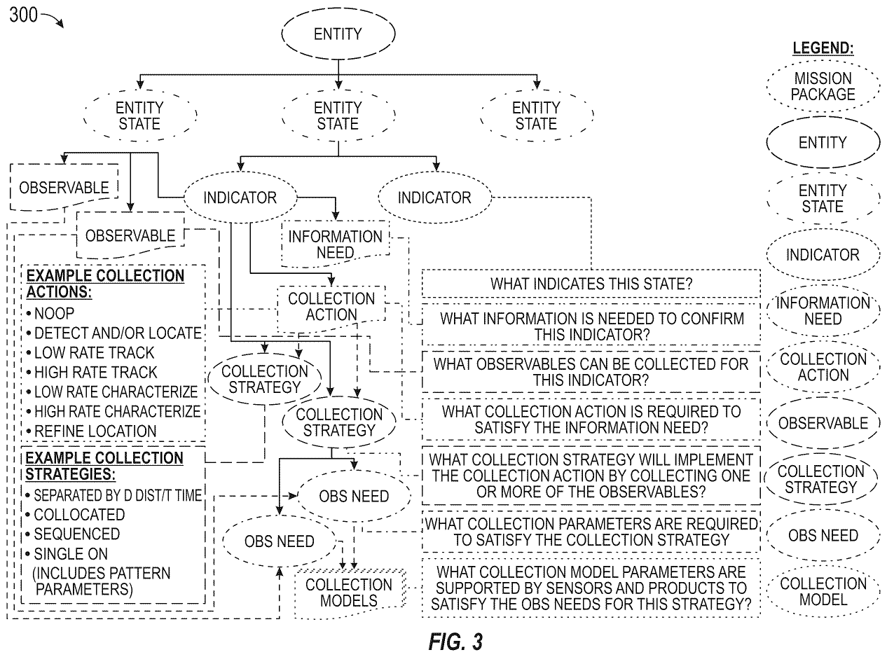

FIG. 3 illustrates an example hierarchical modeling 300 of complex intelligence problems which may be determined by a workflow using the model 105 and agents 110 in accordance with one or more embodiments of the present disclosure. The intelligence problems are examples of sub-questions 145 which may be generated by the model 105 through problem decomposition 140 as described herein. The hierarchical modeling 300 is referenced to a legend indicating mission package, entity, entity state, indicator, information need, collection action, observable, collection strategy, observable need, and collection model.

FIG. 4 is a block diagram of a distributed computer system 400, in which various aspects and functions discussed herein may be practiced. The distributed computer system 400 may include one or more computer systems. For example, as illustrated, the distributed computer system 400 includes three computer systems 402, 404 and 406. As shown, the computer systems 402, 404 and 406 are interconnected by, and may exchange data through, a communication network 408. The network 408 may include any communication network through which computer systems may exchange data. To exchange data via the network 408, the computer systems 402, 404, and 406 and the network 408 may use various methods, protocols and standards including, among others, token ring, Ethernet, Wireless Ethernet, Bluetooth, radio signaling, infra-red signaling, TCP/IP, UDP, HTTP, FTP, SNMP, SMS, MMS, SS7, JSON, XML, REST, SOAP, CORBA IIOP, RMI, DCOM and Web Services.

According to some embodiments, the functions and operations discussed herein for automated problem decomposition for analytic orchestration can be executed on computer systems 402, 404 and 406 individually and/or in combination. For example, the computer systems 402, 404, and 406 support, for example, participation in a collaborative network. In one alternative, a single computer system (e.g., 402) can provide automated problem decomposition for analytic orchestration. The computer systems 402, 404 and 406 may include personal computing devices such as cellular telephones, smart phones, tablets, “phablets,” etc., and may also include desktop computers, laptop computers, etc.

Various aspects and functions in accordance with embodiments discussed herein may be implemented as specialized hardware or software executing in one or more computer systems including the computer system 402 shown in FIG. 4. In one embodiment, computer system 402 is a personal computing device specially configured to execute the processes and/or operations discussed herein. As depicted, the computer system 402 includes at least one processor 410 (e.g., a single core or a multi-core processor), a memory 412, a bus 414, input/output interfaces (e.g., 416) and storage 418. The processor 410, which may include one or more microprocessors or other types of controllers, can perform a series of instructions that manipulate data. As shown, the processor 410 is connected to other system components, including a memory 412, by an interconnection element (e.g., the bus 414).

The memory 412 and/or storage 418 may be used for storing programs and data during operation of the computer system 402. For example, the memory 412 may be a relatively high performance, volatile, random access memory such as a dynamic random access memory (DRAM) or static memory (SRAM). In addition, the memory 412 may include any device for storing data, such as a disk drive or other non-volatile storage device, such as flash memory, solid state, or phase-change memory (PCM). In further embodiments, the functions and operations discussed with respect to automated problem decomposition for analytic orchestration can be embodied in an application that is executed on the computer system 402 from the memory 412 and/or the storage 418. For example, the application can be made available through an “app store” for download and/or purchase. Once installed or made available for execution, computer system 402 can be specially configured to execute the functions associated with automated problem decomposition for analytic orchestration.

Computer system 402 also includes one or more interfaces 416 such as input devices (e.g., camera for capturing images), output devices and combination input/output devices. The interfaces 416 may receive input, provide output, or both. The storage 418 may include a computer-readable and computer-writeable nonvolatile storage medium in which instructions are stored that define a program to be executed by the processor. The storage 418 also may include information that is recorded, on or in, the medium, and this information may be processed by the application. A medium that can be used with various embodiments may include, for example, optical disk, magnetic disk or flash memory, SSD, among others. Further, aspects and embodiments are not to a particular memory system or storage system.

In some embodiments, the computer system 402 may include an operating system that manages at least a portion of the hardware components (e.g., input/output devices, touch screens, cameras, etc.) included in computer system 402. One or more processors or controllers, such as processor 410, may execute an operating system which may be, among others, a Windows-based operating system (e.g., Windows NT, ME, XP, Vista, 7, 8, or RT) available from the Microsoft Corporation, an operating system available from Apple Computer (e.g., MAC OS, including System X), one of many Linux-based operating system distributions (for example, the Enterprise Linux operating system available from Red Hat Inc.), a Solaris operating system available from Oracle Corporation, or a UNIX operating systems available from various sources. Many other operating systems may be used, including operating systems designed for personal computing devices (e.g., iOS, Android, etc.) and embodiments are not limited to any particular operating system.

The processor and operating system together define a computing platform on which applications (e.g., “apps” available from an “app store”) may be executed. Additionally, various functions for generating and manipulating images may be implemented in a non-programmed environment (for example, documents created in HTML, XML or other format that, when viewed in a window of a browser program, render aspects of a graphical-user interface or perform other functions). Further, various embodiments in accord with aspects of the present invention may be implemented as programmed or non-programmed components, or any combination thereof. Various embodiments may be implemented in part as MATLAB functions, scripts, and/or batch jobs. Thus, the invention is not limited to a specific programming language and any suitable programming language could also be used.

Although the computer system 402 is shown by way of example as one type of computer system upon which various functions for automated problem decomposition for analytic orchestration may be practiced, aspects and embodiments are not limited to being implemented on the computer system, shown in FIG. 4. Various aspects and functions may be practiced on one or more computers or similar devices having different architectures or components than that shown in FIG. 4.

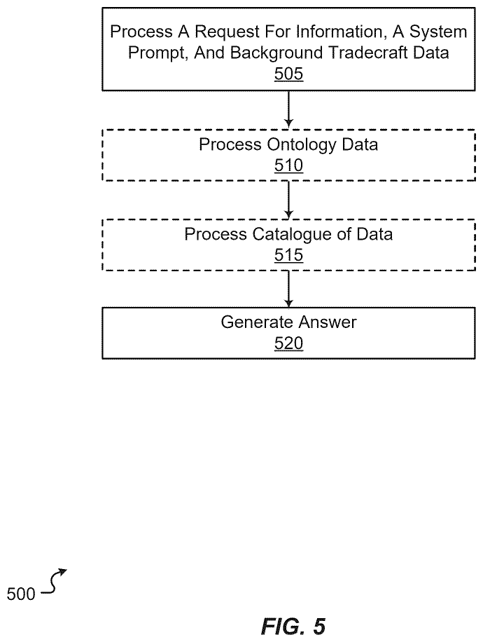

FIG. 5 illustrates an example flowchart of a method 500 in accordance with one or more embodiments of the present disclosure. The method 500 may be implemented by a distributed computer system 400, computer system 402, or the like described herein. The method 500 may be implemented by a model 105 and agents 110 described herein.

At 505, the method 500 includes processing, by one or more computing devices: a request for information; a system prompt associated with answering the request for information; and background tradecraft data associated with the request for information.

At 510, the method 500 may include processing, by the one or more computing devices, ontology data associated with the request for information.

At 515, the method 500 may include processing, by the one or more computing devices, a catalogue of data associated with the request for information.

At 520, the method 500 includes generating, by the one or more computing devices, an answer associated with the request for information, based on processing the request for information, the system prompt, and the background tradecraft data.

In some aspects, generating the answer associated with the request for information is further based on processing, (at 510), by the one or more computing devices, the ontology data associated with the request for information.

In some aspects, generating the answer associated with the request for information is further based on processing, (at 515), by the one or more computing devices, the catalogue of data associated with the request for information.

In some aspects, the method 500 may include generating one or more sub-questions associated with the request for information, based on processing the request for information, the system prompt, and the background tradecraft data, where generating the answer associated with the request for information is based on the one or more sub-questions.

In some aspects, the method 500 may include applying respective weighting factors to each of the one or more sub-questions associated with the request for information, where generating the answer associated with the request for information is based on applying the respective weighting factors.

In some aspects, the method 500 may include generating one or more sub-answers corresponding to the one or more sub-questions, where generating the answer associated with the request for information is based on at least a portion of each of the one or more sub-answers.

In some aspects, the one or more sub-questions are generated by a model included in the one or more computing devices, and the answer is generated by one or more agents included in the one or more computing devices.

In some aspects, the request for information and the answer are associated with providing military intelligence.

In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the various embodiments of the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. A method comprising:
processing, by one or more computing devices:
a request for information;
a system prompt associated with answering the request for information; and
background tradecraft data associated with the request for information; and
generating, by the one or more computing devices, an answer associated with the request for information, based on processing the request for information, the system prompt, and the background tradecraft data.

2. The method of claim 1, wherein generating the answer associated with the request for information is further based on processing, by the one or more computing devices, ontology data associated with the request for information.

3. The method of claim 1, wherein generating the answer associated with the request for information is further based on processing, by the one or more computing devices, a catalogue of data associated with the request for information.

4. The method of claim 1, further comprising:
generating one or more sub-questions associated with the request for information, based on processing the request for information, the system prompt, and the background tradecraft data,
wherein generating the answer associated with the request for information is based on the one or more sub-questions.

5. The method of claim 4, further comprising:
applying respective weighting factors to each of the one or more sub-questions associated with the request for information,
wherein generating the answer associated with the request for information is based on applying the respective weighting factors.

6. The method of claim 4, further comprising:
generating one or more sub-answers corresponding to the one or more sub-questions,
wherein generating the answer associated with the request for information is based on at least a portion of each of the one or more sub-answers.

7. The method of claim 4, wherein:
the one or more sub-questions are generated by a model comprised in the one or more computing devices; and
the answer is generated by one or more agents comprised in the one or more computing devices.

8. The method of claim 1, wherein the request for information and the answer are associated with providing military intelligence.

9. A system configured to:
process a request for information, a system prompt associated with answering the request for information, and background tradecraft data associated with the request for information; and
generate an answer associated with the request for information, based on processing the request for information, the system prompt, and the background tradecraft data.

10. The system of claim 9, wherein the system is configured to generate the answer based on based on processing ontology data associated with the request for information.

11. The system of claim 9, wherein the system is configured to generate the answer based on processing a catalogue of data associated with the request for information.

12. The system of claim 9, wherein the system is further configured to:
generate one or more sub-questions associated with the request for information, based on processing the request for information, the system prompt, and the background tradecraft data,
wherein generating the answer associated with the request for information is based on the one or more sub-questions.

13. The system of claim 12, wherein the system is further configured to:
apply respective weighting factors to each of the one or more sub-questions associated with the request for information,
wherein generating the answer associated with the request for information is based on applying the respective weighting factors.

14. The system of claim 12, wherein the system is further configured to:
generate one or more sub-answers corresponding to the one or more sub-questions,
wherein generating the answer associated with the request for information is based on at least a portion of each of the one or more sub-answers.

15. The system of claim 12, further comprising one or more computing devices comprising:
a model; and
one or more agents,
wherein:
the model is configured to generate the one or more sub-questions; and
the one or more agents are configured to generate the answer based on the one or more sub-questions.

16. An apparatus comprising:
a memory having computer readable instructions and one or more processors for executing the computer readable instructions, wherein the computer readable instructions, when executed by the one or more processors, cause the apparatus to:
process a request for information, a system prompt associated with answering the request for information, and background tradecraft data associated with the request for information; and
generate an answer associated with the request for information, based on processing the request for information, the system prompt, and the background tradecraft data.

17. The apparatus of claim 16, wherein generating the answer associated with the request for information is further based on processing, by the one or more processors, ontology data associated with the request for information.

18. The apparatus of claim 16, wherein generating the answer associated with the request for information is further based on processing, by the one or more processors, a catalogue of data associated with the request for information.

19. The apparatus of claim 16, wherein the computer readable instructions, when executed by the one or more processors, further cause the apparatus to:
generate one or more sub-questions associated with the request for information, based on processing the request for information, the system prompt, and the background tradecraft data,
wherein generating the answer associated with the request for information is based on the one or more sub-questions.

20. The apparatus of claim 19, wherein the computer readable instructions, when executed by the one or more processors, further cause the apparatus to:
apply respective weighting factors to each of the one or more sub-questions associated with the request for information,
wherein generating the answer associated with the request for information is based on applying the respective weighting factors.
